(19) United States
(12) Patent Application Publication
(10) Pub. No.: US 2010/0066501 A1
(43) Pub. Date: Mar. 18, 2010

(54) METHOD AND SYSTEM FOR MONITORING A CONTAINER

(75) Inventors: Keith Ulrich, Bonn-Oberkassel (DE); Stefan Wilms, Köln (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/517,660

(22) PCT Filed: Dec. 3, 2007
(86) PCT No.: PCT/EP2007/010484

§ 371 Date: Aug. 11, 2009

(30) Foreign Application Priority Data
Dec. 5, 2006 (DE) 10 2006 057 643.8

(51) Int. Cl. H04Q 5/22

(52) U.S. Cl. 340/10.1

(57) ABSTRACT

There is provided a method for monitoring a container for holding at least one object. An exemplary method comprises acquiring measured data about an object with a sensor and transmitting the measured data to a transponder, the transponder being separated from the sensor by an interlayer that absorbs or reflects electromagnetic radiation. The exemplary method also comprises transmitting status information from the transponder to a reading unit as a function of the measured data. The exemplary method additionally comprises supplying energy to the transponder from the reading unit, and relaying the energy from the transponder to the sensor.

### CROSS REFERENCE TO RELATED APPLICATIONS

Pursuant to 35 U.S.C. §371, this application is the United States National Stage Application of International Patent Application No. PCT/EP2007/010484, filed on Dec. 3, 2007, the contents of which are incorporated by reference as if set forth in their entirety herein, which claims priority to German (DE) Patent Application No. 10 2006 057 643.8, filed Dec. 5, 2006, the contents of which are incorporated by reference as if set forth in their entirety herein.

### BACKGROUND

In the realm of transporting objects within logistics systems, there is a need to protect the objects from external influences.

The objects can be articles having different properties, especially different sizes and degrees of fragility. In particular, these are objects that can be placed into a container.

Various measures for protecting protect the contents against damage are known from the state of the art.

It is a known requirement that the transportation containers and thus the objects located in them have to be adequately protected against damage, theft or other undesired influences. In order not to have to use elaborately secured and heavy containers, the containers are normally monitored along the transportation route.

Damage to the transported objects can occur, for example, if objects are not transported under specific ambient conditions such as temperature, air composition or humidity, so that particularly food or drugs end up not being transported under the requisite optimal conditions. Therefore, for the operator of a transportation and logistics system, it is advantageous if the ambient conditions of such objects in a container can be monitored and logged. When applicable, the monitoring makes it possible to directly influence the conditions in the transportation containers.

### SUMMARY OF THE INVENTION

An exemplary embodiment of the present invention relates to a method for monitoring a container for holding objects.

Exemplary embodiments of the invention also relate to a logistics system and to a computer program product.

Moreover, exemplary embodiments of the present invention relate to a method that allows improved monitoring of the transportation of objects in comparison to the prior-art methods.

An exemplary embodiment of the present invention comprises a logistics system that is suitable for this purpose.

An exemplary embodiment of the present invention provides for carrying out a method or configuring a logistics system in such a way that measured data about the object is acquired by a sensor, that the acquired measured values are transmitted to a transponder and that the transponder transmits status information to a reading unit as a function of the measured data.

Exemplary embodiments of the present invention also relate to a container to hold objects, to a transportation system to convey the containers, to a network node for use in the logistics system and to a computer program product.

A refinement of the method, of the logistics system, of the container, of the network node and of the computer program product according to an exemplary embodiment of the present invention provides that the reading unit or a data processing unit in communication with it evaluates the status information.

A refinement of the method, of the logistics system, of the container, of the transportation system, of the network node and of the computer program product according to an exemplary embodiment of the present invention is characterized in that the status information is stored.

A refinement of the method, of the logistics system, of the container, of the network node and of the computer program product according to an exemplary embodiment of the present invention provides that the status information is stored in a storage medium installed in the container.

A refinement of the method, of the logistics system, of the container, of the transportation system, of the network node and of the computer program product according to an exemplary embodiment of the present invention is characterized in that the status information is stored in the reading unit and/or in the data processing unit that is in communication with the reading unit.

An exemplary embodiment of the invention provides that the status information is stored only in the reading unit and/or in the data processing unit that is in communication with said reading unit. This has the advantage that storage space in the containers is saved so that they can be produced more easily.

A refinement of the method, of the logistics system, of the container, of the network node and of the computer program product according to an exemplary embodiment of the present invention provides that the data processing unit carries out an evaluation of the status information.

A refinement of the method, of the logistics system, of the container, of the transportation system, of the network node and of the computer program product according to an exemplary embodiment of the present invention is characterized in that at least one handling procedure of the container is carried out as a function of the evaluation.

A refinement of the method, of the logistics system, of the container, of the network node and of the computer program product according to an exemplary embodiment of the present invention provides that the logistical handling procedure comprises diverting the container out of a given transportation process.

A refinement of the method, of the logistics system, of the container, of the transportation system, of the network node and of the computer program product according to an exemplary embodiment of the present invention is characterized in that the handling procedure comprises diverting the container out of a given transportation process.

A refinement of the method, of the logistics system, of the container, of the network node and of the computer program product according to an exemplary embodiment of the present invention provides that the handling procedure comprises the selection of another mode of transportation.

It is advantageous for the selection of another transportation route to be made, for example, if there is a risk that, if an originally intended mode of transportation is retained, the objects will be exposed to a load that is higher than the permissible load of the objects.

An example of a load of the objects that is to be avoided is undesired high thermal stress and/or radiation exposure.

A refinement of the method, of the logistics system, of the container, of the transportation system, of the network node and of the computer program product according to an exemplary embodiment of the present invention is characterized in that the position of the transponder is determined.

A refinement of the method, of the logistics system, of the container, of the network node and of the computer program product according to an exemplary embodiment of the present invention provides that the position of the container is stored.

A refinement of the method, of the logistics system, of the container, of the transportation system, of the network node and of the computer program product according to an exemplary embodiment of the present invention is characterized in that the position is stored in the data processing unit.

A refinement of the method, of the logistics system, of the container, of the network node and of the computer program product according to an exemplary embodiment of the present invention provides that the position of the container is determined and that the position of the container is associated with the status information obtained from the sensor.

A refinement of the method, of the logistics system, of the container, of the transportation system, of the network node and of the computer program product according to an exemplary embodiment of the present invention is characterized in that energy is supplied to the transponder.

A refinement of the method, of the logistics system, of the container, of the network node and of the computer program product according to an exemplary embodiment of the present invention provides that the energy is supplied by means of the reading unit.

A refinement of the method, of the logistics system, of the container, of the transportation system, of the network node and of the computer program product according to an exemplary embodiment of the present invention is characterized in that the energy is relayed from the transponder to the sensor.

A refinement of the method, of the logistics system, of the container, of the network node and of the computer program product according to an exemplary embodiment of the present invention provides that a signal line is established between the sensor and the transponder by means of a connection element.

A refinement of the method, of the logistics system, of the container, of the transportation system, of the network node and of the computer program product according to an exemplary embodiment of the present invention is characterized in that the connection element comprises at least one wire.

A refinement of the method, of the logistics system, of the container, of the network node and of the computer program product according to an exemplary embodiment of the present invention provides that the connection element comprises at least one optical waveguide.

A refinement of the method, of the logistics system, of the container, of the transportation system, of the network node and of the computer program product according to an exemplary embodiment of the present invention is characterized in that the sensor is closer to the object than the transponder is.

A refinement of the method, of the logistics system, of the container, of the network node and of the computer program product according to an exemplary embodiment of the present invention provides that the sensor and the transponder are separated from each other by an interlayer.

A refinement of the method, of the logistics system, of the container, of the transportation system, of the network node and of the computer program product according to an exemplary embodiment of the present invention is characterized in that the interlayer has a thermally insulating effect.

A refinement of the method, of the logistics system, of the container, of the network node and of the computer program product according to an exemplary embodiment of the present invention provides that the interlayer has a shock-absorbing effect.

A refinement of the method, of the logistics system, of the container, of the transportation system, of the network node and of the computer program product according to an exemplary embodiment of the present invention is characterized in that the interlayer absorbs electromagnetic radiation.

A refinement of the method, of the logistics system, of the container, of the network node and of the computer program product according to an exemplary embodiment of the present invention provides that the interlayer reflects electromagnetic radiation.

Many types of transponders are suitable for use according to the invention. Special preference is given to transponders that serve as transmitting and/or receiving devices. In particular, these are receiving devices that, after receiving an external signal, are capable of transmitting a signal of their own.

The term “transponder” is short for “transmitter” and “(signal) responder”.

Special preference is given to the use of transponders that are provided with at least one identifier. Below, such transponders are also referred to as RFID tags.

It is advantageous to replace or augment a visually detectable identification of objects in transportation or logistics systems using RFID technologies involving transponders that can be written and read electronically multiple times. Such systems have the advantage that a great deal of information can be electronically written into and read out of a transponder, as a result of which automatic transportation, sorting, tracking or distribution procedures can be controlled without information having to be displayed visually.

A transponder with identifiers (RFID tags) is preferably configured as an RFID tag. An RFID tag consists of a microchip and an antenna. A code containing processing-relevant information is stored on the chip. In particular, this information is identification information (ID).

Transponders are configured in such a way that, in response to a triggering (radio) signal from a reading device, they themselves transmit and/or receive signals. Active transponders contain a source of energy for their operation. In contrast, passive transponders obtain energy from the signals transmitted by the reading device.

An exemplary embodiment of the present invention comprises a novel logistics system that automates and considerably simplifies the transportation of objects to intended recipients.

According to an exemplary embodiment of the present invention, a logistics system is provided that is characterized by especially high security and reliability.

In this context, the term “logistics system” relates to any system that is suitable for storing, sorting and/or transporting objects.

An exemplary embodiment of the invention preferably comprises a database containing information about the goods to be delivered and about at least one outgoing station provided for the delivery of an object.

It is especially advantageous for the database to contain information about several outgoing stations intended for the delivery of the object.

The method according to an exemplary embodiment of the present invention for monitoring a container for holding objects provides that a sensor in the interior serves to detect status changes in the physical properties of the contents of the container.

Subsequently, the measured data is transmitted to the transponder.

The transponder transmits status information to a reading unit as a function of the measured data.

In a first exemplary embodiment, the measured data itself is transmitted as status information to the reading unit.

In another, likewise advantageous exemplary embodiment, critical parameters derived from the measured data—for example, exceeding of the temperature—are transmitted.

The transmission of selected, compressed and/or reduced values has the advantage that storage and transmission capacities can be utilized more efficiently.

Numerous types of reading devices are possible when transponders are used for relaying the measured values.

Antennas are used that are tuned to the specific wavelength of the electromagnetic radiation of the transponders.

The possibility of reading several transponders in rapid succession makes certain requirements of the reading unit that is going to be used.

It is especially advantageous for the reading unit to be equipped with the BRM function known from the state of the art.

The BRM function (Buffered Read Mode=data filtering and data storage) ensures that the data from transponders that have already been read out are buffered in the reader and is only read out once. This advantage plays a role in applications with bulk recognition (anti-collision) since only “new” transponders are read out each time. Consequently, this increases the data transfer speed.

The information acquired in this manner is subsequently further processed.

Various transmission modalities can be employed for the transmission to the reading unit.

The reading unit is arranged in a transportation system for the container, in a warehouse or in a processing center for the container.

A data processing unit that can preferably be in communication with the reading unit receives this status information from the reading unit.

A refinement of the method according to an exemplary embodiment of the present invention is characterized in that the position of the container is determined by a position-finding device that is in communication with the container, and the position of the container is associated with the status information obtained from the sensor. In this case, the position of the container can be determined by a position-finding device directly on the container or on a transportation system with which the container is being transported. If the position-finding device is situated on an appertaining transportation system, it is preferably in communication with the data processing unit of the container.

The position of the container can be determined, for example, by a position-finding device in the form of a GSM module, a GPS module, and/or a direction-finding transmitter. The various position-finding devices can be used as a function of the required precision of the position determination, whereby they can be used either perpendicularly or in parallel.

A refinement of the method, of the logistics system, of the container, of the network node and of the computer program product according to an exemplary embodiment of the present invention provides that the status information obtained from the sensors is compared to set points, whereby a deviation from a set point is considered as an alarm. The status information is preferably compared in that the measured electrical properties of the conductive layers are compared to a set point of the electrical properties. Here, it can be provided that a deviation of the physical properties of the container material from a set point is not considered as an alarm if the deviation is associated with a position of the container that is stored in the data processing unit as a position in which it is permissible to open the container.

In an exemplary embodiment of the invention, the status information obtained from the sensor is transmitted to a communication module on the container and the communication module transmits the status information to a message-receiving device.

A refinement of an exemplary embodiment of the present invention provides for the use of at least one transponder as the communication module.

An exemplary embodiment of the invention provides for sensor-transponder units in which a sensor is connected to a transponder, especially to an RFID tag.

An exemplary embodiment of the invention provides that two cables establish a serial connection between the RFID tag and the sensor.

Furthermore, the following connections are possible:

one sensor with several RFID tags;

several sensors with one RFID tag and

several sensors with several RFID tags.

The link between the sensors and the RFID tags is also referred to as “intermeshing” in order to refer to the mesh-like structure of the link.

The status information can be transmitted from the communication module to the message-receiving device along the transportation route or after the container has reached the destination. Preferably, the status information is only transmitted along the transportation route if a comparison within the data processing unit indicates that a deviation of the status information acquired by the sensors from set points is considered as an alarm.

The determination of the position of the container and the association of the position with the status information obtained from the sensor is preferably carried out in the data processing unit of the container, but this can also be done in the message-receiving device or in the monitoring center.

In an exemplary embodiment of the invention, the container is provided with an atmosphere measuring device that detects the atmosphere in the interior of the container, and the measured values from the atmosphere measuring device are transmitted to the data processing unit of the container. The atmosphere measuring device can be, for example, a temperature and/or moisture sensor whose measured values are transmitted to the data processing unit of the container.

Another exemplary embodiment of the invention provides that the container is equipped with an object detection device for registering the objects in the container and that data about the detected objects is transmitted to the data processing unit. As the object detection device, an antenna, for example, can be provided that is installed around the opening edge of the container. The objects are registered in that the RFID tags located on the objects are read out when the RFID tags are moved past the antenna as the object is being placed into the container. Moreover, the container can be provided with a bulk detection device that detects the objects once all of the objects have been placed into the container.

When the objects are detected, at least the number of objects placed into the containers is registered in the data processing unit. Each object removed from the container reduces the number of objects recorded in the data processing unit, whereby the procedure of removing an object from the container is registered in that the number of procedures in which the unambiguously identifiable RFID tag belonging to the object is recorded.

In addition to the number of objects placed into the container, preferably additional data about the objects is recorded. In an especially preferred embodiment of the invention, the number of objects and/or additional data about the registered objects is transmitted from the data processing unit to the communication module which then sends the information to a message-receiving device. The message-receiving device can be located, for example, in the vicinity of the receiving location of the objects or in the vicinity of a monitoring center.

This information can be read out and further processed via an interface.

A refinement of the invention also comprises—in addition to a method for monitoring a container—a container having monitoring device according to an exemplary embodiment of the present invention.

The monitoring device may comprise sensors that are capable of detecting at least one status parameter that is present in the interior of the container.

In one exemplary embodiment, the container comprises a data processing unit and position-finding device that is in communication with the container in order to determine the position of the container.

However, it is especially preferred to use containers that are configured in such a way that they interact with a data processing unit located outside of the container.

For this purpose, it is advantageous to configure at least one transponder as a communication device in such a way that measured values detected by at least one sensor and/or status information derived from the measured values are transmitted to a data processing unit.

Such an exemplary embodiment has the advantage that computation procedures are performed at least partially outside of the container. As a result, it is possible to use little or no storage media inside the container. In particular, it is advantageous to dimension the storage media in such a way that they store identification information and/or information about the presence of an event that needs to be evaluated.

In an exemplary embodiment of the invention, details about the event that needs to be evaluated are stored and/or processed outside of the container.

This not only reduces the requisite storage capacity in the containers, but also has the added advantage that subsequent processing procedures of the shipment are simplified.

Thus, for example, containers whose contents were subject to severe stresses can be diverted out of a given transportation process.

An even more important aspect is the replacement of damaged objects with new objects.

This is especially important in the case of objects whose use at a specific location is particularly crucial. This applies especially to drugs and medical aids.

Preferably, the container has a communication module that is in communication with the data processing unit as well as an atmosphere measuring device such as a temperature and/or moisture sensor. In an exemplary embodiment of the invention, the container also has a protective covering. Moreover, it is advantageous to configure the container with an object detection device for registering at least the number of objects that have been placed into the container.

The method according to an exemplary embodiment of the present invention has the advantage that the state of a container can be comprehensively monitored during the transportation of objects. Techniques for measuring and monitoring the physical properties of a container material and/or of the ambient conditions can be used together with a position-finding device to associate a position of the container with an event that has occurred to said container or with a status. This makes it possible to precisely determine the position and thus to determine, for example, an area of responsibility in which an event has occurred.

If several position-finding devices having different levels of precision are used, they can be used as a function of the requisite precision range. It is especially advantageous to use a communication module that can transmit acquired data to a monitoring component continuously or else in case of an alarm.

In order to already start the monitoring at the time when the container is being filled, it is advantageous to use an object detection device that allows the registration of all of the objects in the container. This information can, in turn, be associated with a position of the container in question and the communication module can be used to send the data to various message-receiving devices. In this manner, it can be logged that the objects that were to be transported were actually placed into the container and that any theft that might have occurred can only have taken place along the transportation route.

This is especially advantageous for the transporter of a container with objects since, together with the status sensors and the position-finding means, any undesired event that occurs to the container can be tracked without having to take into account any uncertainty about the content of the container before the start of the transport.

### BRIEF DESCRIPTION OF THE DRAWINGS

The figures show the following:

FIG. 1 is a schematic depiction of a container according to an exemplary embodiment of the present invention;

FIG. 2 is a schematic depiction of a container with a protective covering in accordance with an exemplary embodiment of the present invention;

FIG. 3 is a schematic depiction of a container with a device that registers objects in accordance with an exemplary embodiment of the present invention;

FIG. 4 is a schematic depiction of a transportation process of the container, including a temperature profile in accordance with an exemplary embodiment of the present invention;

FIG. 5 is a schematic depiction showing the integration of the transportation process shown in FIG. 4 into a monitoring system (Shipment Control & Management—SCM) in accordance with an exemplary embodiment of the present invention;

FIG. 6 is a perspective view of a container showing the manual acquisition of data from a transponder 600 that is located on a container 601, by a reading device 602 in accordance with an exemplary embodiment of the present invention;

FIG. 7a is a perspective view of a container in which a sensor 701 is configured as a sensor surface and is located among objects 702, 703, 704 and 705 in the interior of a container 706 in accordance with an exemplary embodiment of the present invention;

FIG. 7b is a perspective view of a container in which a sensor strip 801 is located among objects 802, 803, 804, 805, 806, 807 in the interior of a container 808 in accordance with an exemplary embodiment of the present invention;

FIG. 8a is a perspective view of a container in which circular sensors are arranged in the interior of the container in accordance with an exemplary embodiment of the present invention;

FIG. 8b is a perspective view of an alternative container in which circular sensors are arranged in the interior of the container in accordance with an exemplary embodiment of the present invention;

FIG. 9 is a cross-section view through a transportation container according to an exemplary embodiment of the present invention, with several sensors and transponders;

FIG. 10 is a perspective view of a container according to an exemplary embodiment of the present invention;

FIG. 11 is a perspective view of a container according to an exemplary embodiment of the present invention in which a sensor is located in the area of the objects and is in communication with a transponder arranged outside of the interior of the container, and

FIG. 12 is a diagram showing strips arranged next to each other in order to illustrate practical length differences among various sensor-transponder combinations in accordance with an exemplary embodiment of the present invention.

### DETAILED DESCRIPTION OF SPECIFIC EMBODIMENTS

An exemplary embodiment of the present invention comprises a wide array of combinations of sensors and transponders.

Thus, for example, it is possible to use several identical sensors in order to achieve a two-dimensional or three-dimensional detection of measured variables, for example, to create a temperature image.

Moreover, it is preferred to use several different types of sensors in order to detect different measured variables—for example, temperature, humidity or radiation exposure.

Moreover, it is advantageous for different transponders to be used. This allows operation with different operating conditions, especially different operating frequencies, for example, UHF, HF.

Furthermore, it is advantageous to provide several identical transponders in order to improve the reading quality and increase the reading rate. Such applications are advantageous especially when the reading of the data has to be carried out especially quickly and/or reliably.

For this purpose, it is advantageous to arrange the transponders in a suitable geometry, for example, in the form of a net, a ring or a mat.

The following are likewise comprised:

several identical sensors with one transponder;

several different sensors with one transponder;

several identical transponders with several identical sensors;

several identical transponders with several different sensors;

several different transponders with several different sensors;

several different transponders with several identical sensors.

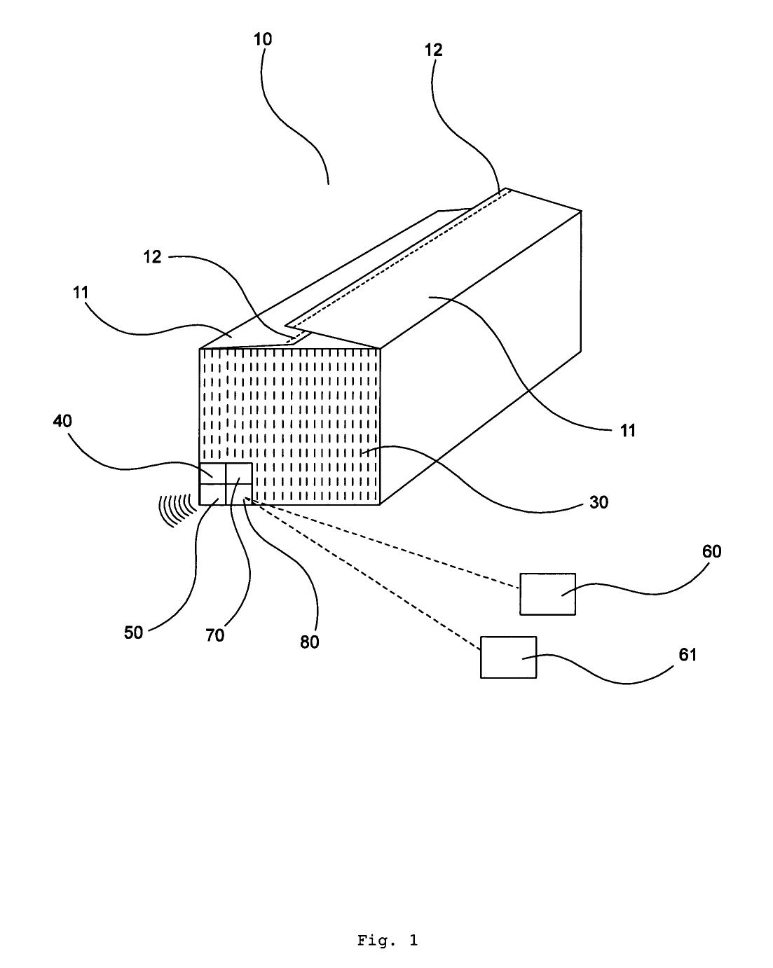

The container 10 schematically shown in FIG. 1 for holding and transporting objects can be, for example, a rectangular container with a bottom surface, four side walls and a lid arrangement. The container can be made of various materials such as cardboard, wood, plastic, metal or combinations thereof. If a soft material such as cardboard is used, it can be advantageous to provide the cardboard with a protective covering 100 that completely surrounds the container. This protective covering can likewise be made, for example, of plastic, wood or metal.

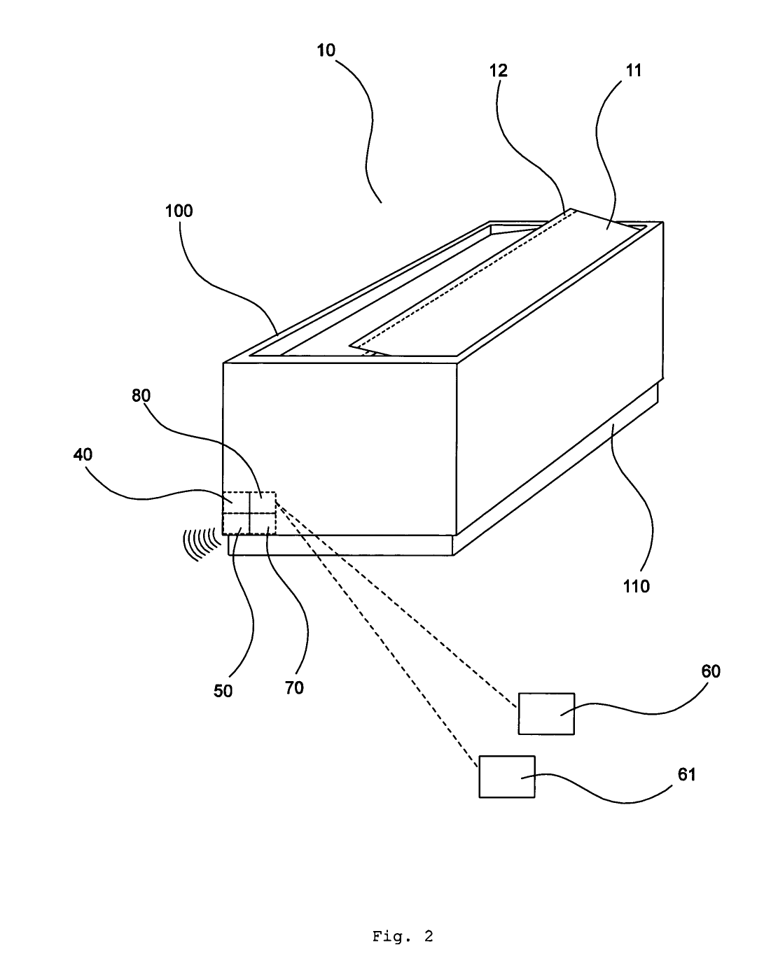

Such a container with a protective covering is shown by way of an example in FIG. 2. In an especially preferred embodiment of the invention, the protective covering 100 comprises a pallet bottom 110 made of wood and side walls and a lid made of rigid plastic. The bottom 110 is configured like regular pallets and is joined permanently or detachably to the side walls, which are made of rigid plastic. The protective covering 100 can be permanently joined to the basic container 10, although it has proven to be advantageous to configure the protective covering 100 so as to be separable from the basic container 10. In this manner, the basic container can be transported over segments of a transportation route so that it is protected, whereas the container can be transported or stored without the protective covering over other transportation segments where no additional protection is required. Moreover, this allows the protective covering 100 to be re-used and to be employed for a large number of transportation processes, even if the basic container 10 is damaged and can no longer be used.

Preferably, all of the wall surfaces of the container 10 are provided with surfaces made of electrically conductive material that serves as a sensor 30 for detecting state changes in the physical properties of the object. Either the entire surface or else only partial surfaces of the container can be coated with conductive material. Preferably, the container surface is provided with several conductive strips that are printed directly onto the container material in the form of electronic ink or that are printed onto a polymer film coating. In FIG. 1, in order to simplify the depiction, only the front side wall of the container is shown with conductive strips 30. The conductive strips are arranged in such a way that a physical change in the properties of the container material and thus damage to the container material brings about a change in the electrical properties of the strips.

In order to evaluate the status information detected by the sensor, the conductive strips 30 are in communication with a data processing unit 40 that is, in turn, in communication with the container 10. The data processing unit advantageously has at least a voltage source, computing means for processing data, and storage media. The data processing unit is preferably situated directly on or in the container 10. In order to protect the data processing unit from unauthorized access, the individual components can be incorporated, for example, into the container material.

The conductive strips 30 of the container can be used in various ways as a sensor to monitor the state of the container material. For example, the resistance of the strips can be constantly monitored, whereby a fluctuation in the resistance is considered as damage to the container material. Since this opens up the possibility of manipulation of the monitoring if the strips are bridged, it has proven to be advantageous to monitor an analogous resistance value. Here, it is advantageous to use reference strips so that natural changes in the resistance, for example, due to ageing, moisture or temperature effects, can be taken into account. If a deviation from the set point specified by the reference strips is measured, then this is registered as damage to the container material and, if applicable, as an alarm.

Various lid arrangements can be provided so as to register not only damage to the container material, for example, due to cuts, but also the opening of the container lid. If, in an area of application, it is merely necessary to register the one-time opening of the lid, this can be achieved, for example, in that the conductive strips 30 extend likewise in the area of the container lid surfaces 11. In the manner known from the state of the art for monitoring envelopes, it can be provided that the closure surfaces are configured in such a way that the conductive strips 30 adhere slightly to the container material, whereas they adhere strongly to closure materials such as adhesive tapes. For example, the closure of a container lid 11 made of cardboard can be configured in such a way that two or four lid surfaces are folded over and joined together. Such a lid with two visible lid surfaces is shown in FIG. 1. The lid surfaces 11 are preferably joined by means of an adhesive tape (not shown here) that is applied onto areas of the surfaces to which the conductive strips adhere slightly. Consequently, the adhesive tapes cannot be removed to open the lid without the conductive strips underneath them also being detached, as a result of which a change in the electrical properties of the strips is registered.

In another exemplary embodiment of the invention, overlapping lid surfaces 11 are provided with capacitive joining surfaces 12 that extend, for example, along the edges of the lid surfaces, as is shown in FIG. 1. When the lid is closed, two joining surfaces lie on each other so that the two joining surfaces 12 form a capacitive element with a relatively high capacitance. If the lid is opened, the distance between the joining surfaces 12 increases and the capacitance decreases sharply. The joining surfaces are likewise in communication with the data processing unit 40 and the reduction of the capacitance can thus be registered as an opening of the lid.

A lid arrangement with capacitive joining surfaces 12 has the advantage that there is no need for a tight closure by means of adhesive tape and furthermore, that opening and closing multiple times can be registered without the lid closure being destroyed in the process. Objects 20 can thus be removed from the container or objects added to it, if this has been authorized, whereas unauthorized procedures are registered.

In an exemplary embodiment of the present invention, the container 10 is in communication with a position-finding device 50 for determining the position of the container. The position-finding device 50 is preferably situated directly on the container, but it can also be located on a transportation system with which the container is being transported. For example, the position-finding device can be located on an airplane, truck or ship on which the container is being transported.

The position-finding device can be, for example, a direction-finding transmitter, a GSM module or a GPS module. The direction-finding transmitter is attached to the container or to an associated transportation system and can be found by a remotely located station. In this case, the information about the position of the container is not available to the data processing unit 40, so that the direction-finding transmitter is advantageously augmented by another module such as a GPS (Global Positioning System). In the case of GPS positioning, the current position can be transmitted to the associated satellite receiver so that the position of the container is available to the data processing unit 40. This likewise applies to a GSM module to which the position is transmitted using cell positioning. The use of a GSM module is also advantageous since, at the same time, it can be used as a communication module for sending information.

The position-finding device mentioned by way of an example can be used either perpendicularly or in parallel. In an exemplary embodiment of the invention, at least two of the mentioned position-finding devices are used for purposes of determining the position of the container. This exemplary embodiment has the advantage that the position of the container can be determined using the various position-finding techniques with a variable level of precision and, if necessary, also within closed spaces. The direction-finding transmitter, for example, can be used in order to be able to determine the position of the container as accurately as possible, whereas positioning by a GPS and/or GSM module is sufficient for determining the position within a larger area.

In another exemplary embodiment of the invention, the container 10 also has an atmosphere measuring device 70 with which the atmosphere conditions inside or at the container can be measured. The atmosphere measuring device is likewise in communication with the data processing unit 40. The measuring device can be, for example, a temperature or moisture sensor whose measured values are transmitted to the data processing unit 40.

The container also has a communication module 80 that is in communication with the data processing unit 40. The communication module 80 can be, for example, a PC interface for reading out data. However, special preference is given to the use of a GSM module with which messages can be transmitted and received in the GSM network. The communication module is configured in such a way that it can transmit data obtained by the data processing unit to a monitoring center 60 and/or to alternative message-receiving means 61. The monitoring center can be, for example, a main office of the transportation and logistics company that is transporting the objects in the container. Other message-receiving devices 61 can be located at the premises of the sender or recipient of the transported objects, so that these stations can likewise receive messages from the container.

The described structure of the container 10 with various sensors, a position-finding device 50 and a communication module 80 makes it possible to monitor the container, whereby various parameters such as whether the container is intact, its position and the ambient conditions can be monitored. Here, all of the available or selected parameters can be monitored. The monitoring for to check if the container 10 is intact is done by the sensor 30 in the form of conductive surfaces, whereby the measured electrical properties of the sensors are transmitted to the data processing unit 40. Thus, it can be monitored whether a container has been cut open, for example, by sharp objects along the transportation route, so that objects could have been removed without authorization.

Moreover, it can be advantageous to monitor a planned route of the container and to continuously determine the current position of the container using the position-finding device 50. Thus, it is possible to track whether a container has moved away from a prescribed route, which is an indication of an irregularity that might need to be checked or even an indication of theft of the objects in the container. The determination of the position can especially serve to associate an alarm with a position of the container where an irregularity has occurred.

The monitoring of certain values for the temperature and/or moisture inside the container is carried out by the appropriate sensor 30 whose values are likewise transmitted to the data processing unit. Thus, for example, when food or drugs are being transported, it is possible to monitor whether the required atmospheric conditions have been maintained.

Methods for monitoring the container 10 can provide for various types of alarms and responses to them. It can be provided, for example, for the data acquired at the container to be stored in the data processing unit 40 and/or to be continuously transmitted via the communication module 80 to a monitoring center 60 and/or to alternative message-receiving means 61. If the data is only stored, it can be read out and processed via an interface, for example, at the destination of the container. This can be carried out by connecting the communication module 80 to a receiving device, whereby the connection can either be made by direct contact or by long-distance transmission. Suitable communication devices for the long-distance transmission include, for example, RFID chips in the container whose stored data can be read out.

The deviations of the measured values from set points can likewise be evaluated in the data processing unit 40 itself or in a separate evaluation unit. In the latter case, the data is read out, for example, at the destination, and an evaluation ascertains whether deviations from desired conditions have occurred. This can be advantageous if the application in question merely requires that it be ascertained whether a container was transported correctly and, if applicable, where damage occurred.

However, it is especially advantageous to monitor the container during the transportation so that, if applicable, an immediate response can be made to the alarm in question can be made. In this case, the communication module 80 already transmits data about the container to the monitoring center 60 while the container is on the transportation route. Here, it can be advantageous for the data processing unit not to send a continuous data stream but rather for it to carry out an evaluation of the measured status information and to trigger an alarm in case of deviations from set points. Only after an alarm has been triggered is information about the status of the container transmitted to the central monitoring unit 60 or to alternative message-receiving device 61. This notification preferably comprises the type of the deviation from a set point and the specific position where the deviation occurred. If, for example, an alarm is triggered pertaining to whether the container is intact, the current position of the container is associated with said alarm and it is possible to check on site whether the container has been damaged within the scope of theft.

The container according to an exemplary embodiment of the present invention also allows other methods for checking the authorized opening. For example, it can be programmed in the data processing unit 40 that the container may only be opened at a certain location. Consequently, when the container is opened, the position of the container currently detected by the position-finding device 50 is compared to the stored location where such opening is authorized. If these positions match, then the opening is registered as being correct. If the comparison shows that the positions differ from each other, then this is considered as an unauthorized opening of the container. Here, various tolerances can be programmed for the deviation of a position, whereby it is, once again, advantageous to use various position-finding devices with differing levels of precision. For example, a direction-finding transmitter can be used if the position at the time of the opening is supposed to be accurate to within about 1 meter. This is the case, for example, if a container is only allowed to be opened in certain rooms in a building. If a larger area is permissible for the opening, then position-finding devices such as GSM or GPS modules with less precision can be used.

In another exemplary embodiment of the invention, the authorized opening of a container calls for an access code or a release of the container. The user can enter the access code directly into the data processing unit. Especially advantageously, however, an access check can be performed in that the data processing unit 40 requests a release of the container from the monitoring center 60 or from alternative components via the communication module 80. Once certain conditions have been fulfilled, the monitoring center transmits, for example, an access code to the data processing unit 40 and the container can be opened, without this being considered as an unauthorized access. In this manner, it can likewise be achieved that the transmission of an access code from several components or users is necessary in order to authorize the opening of the container without triggering an alarm.

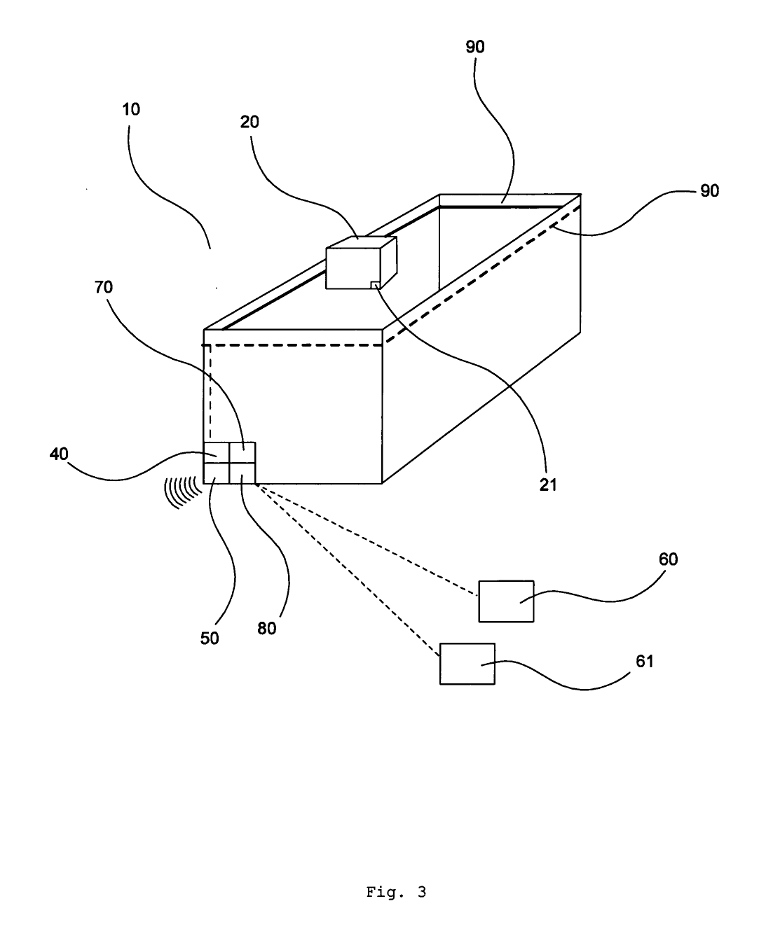

In an exemplary embodiment of the invention, the container is provided with an object detection device 90 for registering the objects in the container 10. Such an arrangement with an antenna that is installed around the opening edge of the container 10 is shown schematically in FIG. 3. In order to simplify the depiction, the lid surfaces of the container are not shown here. In order to be detected by the antenna, the objects 20 are preferably provided with an RFID tag 21 that is read out at the antenna when such an object is moved past. In this manner, the object is detected, whereby the antenna 90 is connected to the data processing unit 40 in which the detection of the objects is registered. The objects can also be provided with other forms of identification that can be detected by the antenna, but RFID tags offer the advantage that they are already attached to various objects for identification purposes, and that, in some cases, additional data can be read out.

When the objects are detected, at least the number of objects placed into the container is registered, and the data processing unit also provides a computing device that registers when an object is removed from the container. This can be achieved, for example, in that the number of procedures is stored in which an unambiguously identifiable RFID tag belonging to an object is detected. If the number of detection procedures is an even number, the object is registered as no longer being in the container. If the number of procedures is an odd number, the object is registered as being in the container.

In addition to the detection of the objects by an edge antenna as shown in FIG. 3, as an alternative, a bulk detection of the RFID tags 21 of all of the objects in the container can be provided once the filling procedure has been completed. The bulk detection can be triggered by an operator, for example, after the filling procedure. In order to prevent objects from being removed again from the container without authorization after the detection, an edge antenna can additionally be provided which registers the removal of an RFID tag that was already registered by the bulk detection.

The detection of the objects 20 by the object detection device 90 can also provide for the reading out of additional data from the associated RFID tag 21. This data can include, for example, information such as the sender or recipient of the object, information about required atmospheric conditions during the transportation, a prescribed transportation route or data about the identification of the object. This data is likewise stored and, if applicable, further processed in the data processing unit 40. For example, set points for the monitoring of the container can be generated on the basis of the data.

The container according to an exemplary embodiment of the present invention having a position-finding device 50 allows the association of the position of the container with the detected objects 20. Thus, it can be stored in the data processing unit that a number of specific objects was placed into a container at a given location. The communication module 80 also makes it possible to transmit a message to this effect to a message-receiving device 61 and/or to a monitoring center 60 indicating that objects have been placed into a container. If the communication module is a GSM module, it can send a text message to the monitoring center 60 or to an appropriate receiving means 61. As a result, for example, the sender can receive a confirmation that the correct number and type of objects have been placed into a container at a sending location.

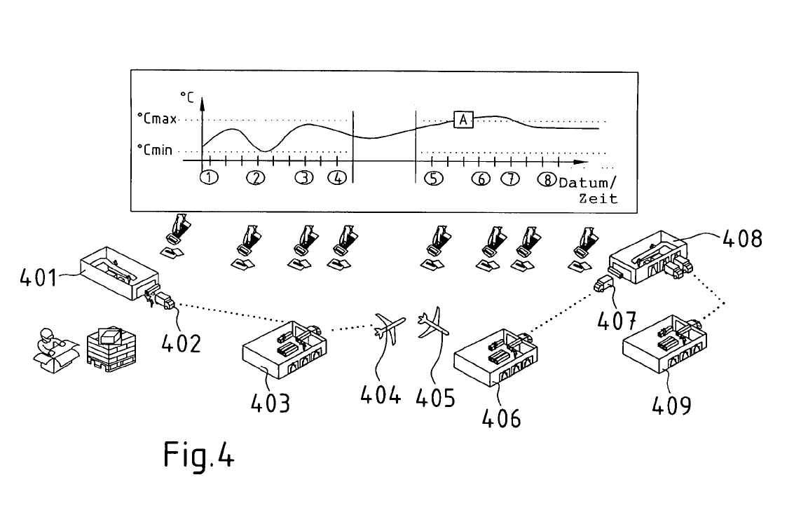

FIGS. 4 through 12 show a cold chain configured according to an exemplary embodiment of the present invention.

FIG. 4 is a schematic depiction of a transportation process, including a temperature profile.

The logistics chain shown makes it possible to transport objects that have to remain refrigerated over any desired distance, for example, even transcontinentally.

The person skilled in the art of logistics will be aware of the fact that the temperature is but one possible parameter of the transportation that needs to be secured.

In particular, of course, instead of and/or in addition to the temperature, it is likewise possible to check and monitor other variables that are necessary to ensure the product quality of the objects, and to make sure that they are observed.

Examples of other parameters that might need to be monitored and observed are the humidity and/or the effects of impacts.

The measures according to the invention make it possible to achieve the following objectives:

ensuring the product integrity of the objects;

quality management;

compliance with statutory requirements;

initiation of corrective measures;

initiation of preventive measures and

process control as well as process optimization.

An exemplary embodiment of the invention provides for calculating an anticipated duration of utilization of the objects.

In particular, sensor RFID units are used according to an exemplary embodiment of the present invention that monitor temperature distribution and that determine an overall effect on the objects.

Here, the term overall effect preferably refers to the weighting of instances of exceeding the temperature and times when excess temperatures occurred.

In an exemplary embodiment, a calculation of the extent to which the temperature has been exceeded is possible using a computing unit in the area of the reading unit.

However, it is likewise possible and advantageous to carry out the calculation in a data processing unit that is in communication with the reading unit.

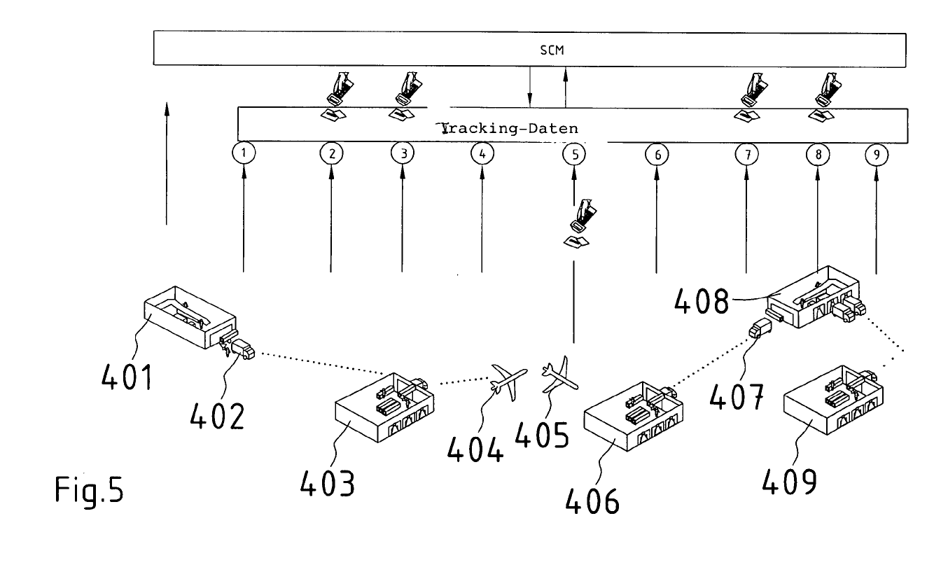

FIG. 5 shows an integration of the transportation process shown in FIG. 4 into a monitoring system (Shipment Control & Management—SCM).

FIG. 6 shows the manual detection of data from a transponder 600 that is located on a container 601, using a reading device 602.

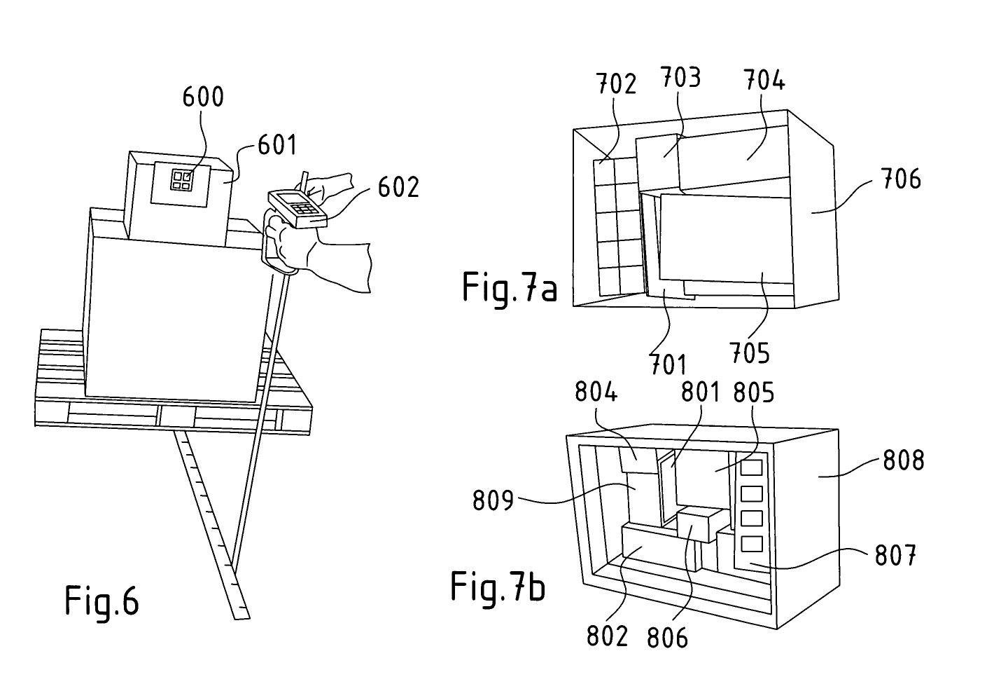

FIG. 7a shows an exemplary embodiment of a container in which a sensor 701 is configured as a sensor surface and is located among objects 702, 703, 704 and 705 in the interior of a container 706.

FIG. 7b shows an exemplary embodiment of a container in which a sensor strip 801 is located among objects 802, 803, 804, 805, 806, 807 in the interior of a container 808.

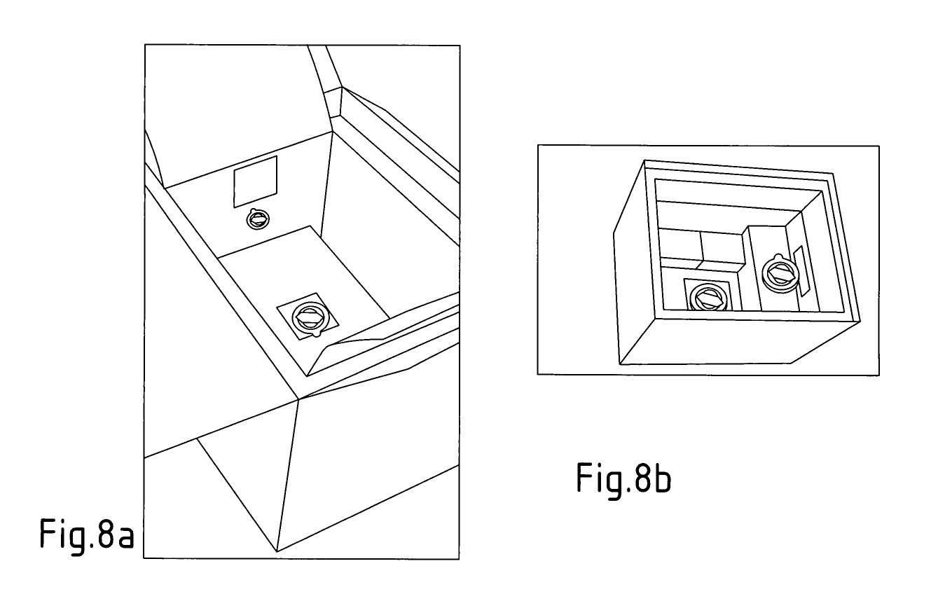

FIG. 8a shows an exemplary embodiment of a container in which circular sensors are arranged in the interior of the container.

FIG. 8b shows another exemplary embodiment of a container in which circular sensors are arranged in the interior of the container.

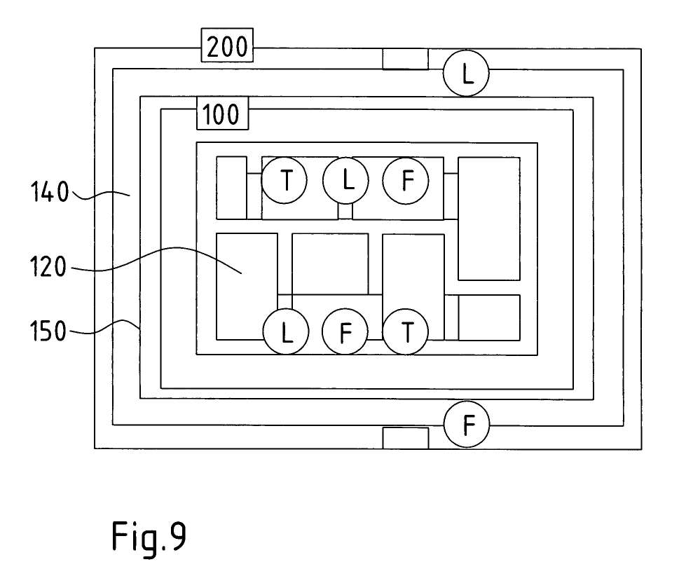

FIG. 9 is a cross-section view through a transportation container according to an exemplary embodiment of the present invention, with several sensors and transponders.

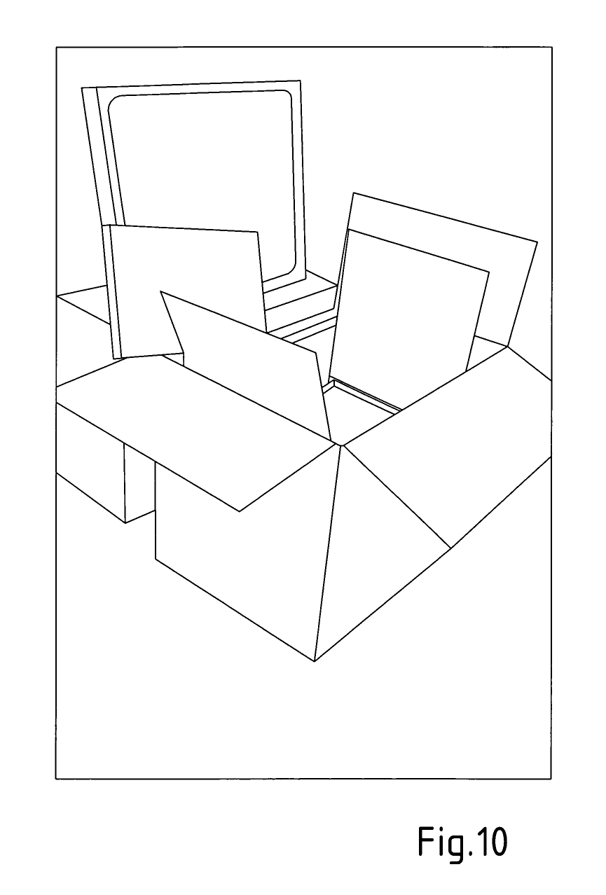

FIG. 10 shows a perspective view of a container according to an exemplary embodiment of the present invention.

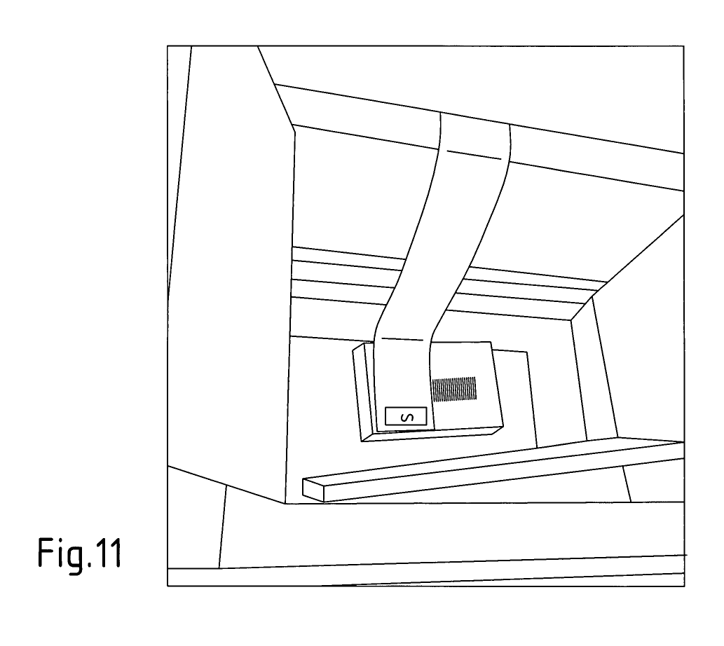

FIG. 11 shows a container according to an exemplary embodiment of the present invention in which a sensor is located in the area of the objects and connected to a transponder located outside of the interior of the container.

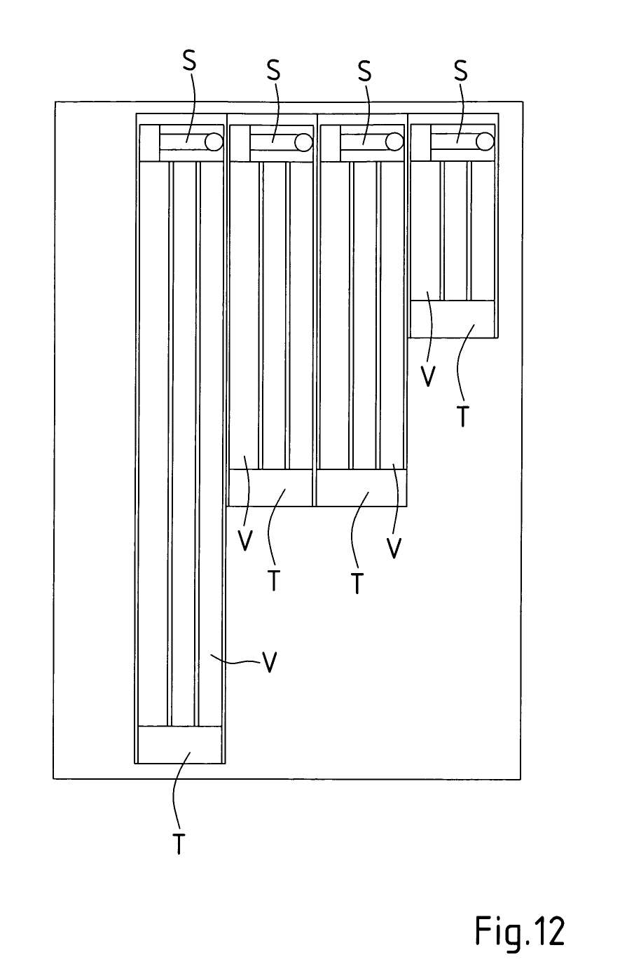

FIG. 12 shows strips arranged next to each other in order to illustrate advantageous length differences between different sensor-transponder combinations according to an exemplary embodiment of the present invention.

An exemplary Radio Frequency Identification (RFID) allows an automated identification (radio identification) and localization of objects.

In an exemplary embodiment, an RFID system comprises the following:

transponders (also called RFID tag, smart tag, smart label or RFID chip);

reading devices with associated antenna (also called readers), and

integration with servers, services and other systems (middleware).

Although transponders that take up little or no storage space are especially advantageous, it is likewise possible to use transponders that store data.

The data is preferably read contact-free and without visual contact. Transponders without data storage are preferred.

It is especially advantageous to acquire data—to perform measurements—in response to a request.

The data is transmitted between the transponder and the reading device using electromagnetic waves. At low frequencies, this is done inductively via a near field and, at higher frequencies, via an electromagnetic far field.

RFID tags can have a re-writable memory in which information can be stored during its service life.

The other characteristic parameters such as, for example, radio frequency, transmission rate, service life, cost per unit, storage capacity, reading range and functional scope also differ, depending on the area of application.

In principle, RFID communication functions as follows: the reader generates a high-frequency electromagnetic alternating field that is received by the antenna of the RFID tag. Induction current is formed in the antenna coil as soon as it approaches the electromagnetic field. This activates the microchip in the RFID tag. In the case of passive tags, the induced current also charges a capacitor that constitutes a permanent source of energy for the chip. In active tags, this is done by a built-in battery.

Once the microchip has been activated, it receives commands that the reader modulates in its magnetic field. Since the tag modulates an answer into the field emitted by the reader, it transmits its serial number or other data requested by the reader.

In this process, the tag itself does not emit a field but rather only changes the electromagnetic field of the reader. Here, the HF tags at 13.56 MHz differ from the UHF tags at 865-869 MHz (European frequencies).

HF tags use load modulation, that is to say, they consume the energy of the magnetic alternating field by short-circuiting. This can be detected by the reader. Through the link to the magnetic alternating field, this technology functions exclusively in the near field. Therefore, the antennas of a near-field tag constitute a coil.

UHF tags, on the other hand, use the electromagnetic far field to transmit the response; this method is called backscattering. Here, the electromagnetic wave is either absorbed or reflected with the largest possible backscattering cross section. The antennas are usually dipoles; the chip is located in the center of the RFID tag.

Since metal reflects this radiation very strongly, it impairs the reading procedure.

Moreover, certain substrate materials ‘detune’ the resonance frequency of the tag, which is why it is provided that the tags are adapted to the materials. Modern printers that are capable of printing on RFID tags and, at the same time, writing on them, can later—depending on the product—cut perforations into the antennas so that the antennas are optimally adapted to the materials that are to be glued on.

Since the energy supply of the microchip has to be continuously ensured in both methods (a commercially available UHF tag with a Philips chip according to the EPC 1.19 Standard requires a current of about 0.35 microamperes for the chip), the reader has to generate an enduring field. In the UHF area, this is called a “continuous wave” (CW). In view of the fact that the field strength decreases quadratically with the distance and this distance has to be traversed in both directions—from the reader to the tag and back—this continuous wave has to be quite powerful. Normally, between 0.5 and 2 watts of equivalent isotropically radiated power (EIRP) are used here.

In order to read out the tags, in the UHF range, several, for example, 10, free channels are available with a power of, for instance, 2 watts, above one channel and below three channels that can only be operated at a lower power. All of the channels extend over a width of 200 kHz. The tag response is given by the modulation of the response signal at 200 kHz to the continuous wave, as a result of which a sideband is formed 200 kHz above and below this continuous wave, hence, it is precisely in an adjacent channel.

In order to be able to simultaneously use as many RFID readers as possible in an environment, one strives to use the entire spectrum of the channels to the extent possible. A frequently used variant is to assign the channels 1, 4, 7 and 10 to the reader. Then, channels 0, 2, 3, 5, 6, 8, 9 and 11 would be available for the sidebands, whereby channel 0 and 11 may only be operated at a lower power, but this is not a problem since here only the tag response is transmitted and not a continuous wave.

Moreover, problems can arise if the RFID tag is located directly on the product. In order to solve this problem, it is advantageous to use flap or flag tags that project at a right angle away from the product and are thus at a great distance from the product.

The decisive factors for the size of the transponder are the antenna and the housing. The shape and size of the antenna depends on the frequency or wavelength. Depending on the required application, transponders are offered in various shapes, sizes and protection classes.

RFID tags, depending on the area of application, can even be as large as books (e.g. in sea-going freight container logistics). However, it is advantageous to produce very small RFID tags that can easily be integrated into the containers. The range of passive transponders is dependent not only on the frequency but also to a decisive extent on the coil size.

Small battery-free RFID tags do not have their own source of energy and they have to obtain their supply voltage by means of induction from the radio signals of the reading units. This reduces the costs and the weight of the chips but, at the same time, also diminishes their range. This type of RFID tags is used, for example, for product authentication or product labeling, for payment systems and document tracking, since here the costs per unit are the crucial aspect. RFID tags with their own source of energy achieve a considerably greater range and have a larger functional scope, but they are more laborious to manufacture.

Encoded information as control instruments for parcel logistics is incorporated into the transponders.

In particular, the transponders can contain consecutive numbering optionally with a check digit—as well as other numbering and address information or other information that serves to classify the shipment or for advertising purposes.

Especially extensive data volumes can be incorporated into smart transponders.

RFID identification systems—“smart transponders”—make it possible to optimize the logistical processes.

Therefore, they are suitable for influencing—including controlling—flexible distribution systems for route-optimized handling of the shipments.

For the operation, especially for signal modulation, the RFID microchip has to be supplied with energy. Here, a distinction is made between two types of RFID tags:

1. Passive RFID tags obtain their energy for supplying the microchip from the radio waves they receive. With the antenna as the coil, a capacitor is charged by means of induction and it supplies the tag with energy. The range here is from a few millimeters to several centimeters.

2. Active RFID tags obtain the energy for supplying the microchip from a built-in battery. Normally, they are in the resting state or are not transmitting any information in order to prolong the service life of the source of energy. Only when a special activation signal is received is the transmitter activated. This allows a considerably larger range, which can amount to about 100 meters.

### Frequency Ranges

The following frequency bands are advantageous for the envisaged use:
Low frequencies (LF, 30-500 kHz). These systems have a small range, function flawlessly in the most often used 64 bit read-only technology and are fast enough for most applications. In the case of larger data volumes, the transmission times are longer. LF transponders are inexpensive to purchase, can withstand high levels of humidity and moisture, they are compatible with the use of metal, and they are offered in a wide variety of shapes.
High frequencies (HF, 3-30 MHz). Short to medium range, medium transmission speed, medium to inexpensive price class. The so-called smart tags operate in this frequency range (usually 13.56 MHz).
Ultra-high frequencies (UHF, 850-95 MHz, 2.4-2.5 GHz, 5.8 GHz). Long range (3 to 6 meters for passive transponders, 30 meters or more for active transponders) and high reading speed. Low prices for passive transponders, a tendency towards high prices for active transponders. Typical frequencies are 433 MHz, 868 MHz (Europe), 915 MHz (U.S.A.), 950 MHz (Japan) and in the 2.45 GHz and 5.8 GHz microwave ranges.

Most RFID tags send their information in plain text, but a few models also have the capability to transmit their data in encrypted form.

Writability

1. The data record of the transponder is incorporated at the point in time when the chip is manufactured (consecutive number),
especially preferred:
only identification purposes; →less manufacturing effort; lower energy consumption.

2. Writable transponders:
EEPROM (electrically erasable programmable read-only memory)—inductively coupled RFID;
FRAM (ferromagnetic random access memory);
SRAM (static random access memory)—requires an interruption-free source of energy.

Energy Supply

1. Passive transponders—energy supply is obtained from the (electrical/magnetic) field;

2. Semi-passive transponders, (back-up) battery for the use of connected sensors, but not for data transmission;

3. Active transponders—battery in normal case for the expansion of the range of the data transfer, but also for parallel sensor systems.

It is especially advantageous to use RFID tags that have at least one sensor input.

For example, an RFID tag with one or more sensor inputs will modify the one label data word bitstream that is read by a label query-1-recognition device.

An RFID tag can have a sensor input that is capable of receiving variable signals from one or more sensors, an analog variable or a digital variable.

The amplitude of the RFID tag modulates the CW-HF carrier of the HF generator with its data word bitstream by charging and discharging the resonance circuit or antenna of the RFID tag in accordance with the binary values of this data word bitstream.

The data word bitstream is a series of ON-OFF pulses that constitute, for example, a serial data word synchronization head and the RFID tag number.

Parity bits or a checksum value can likewise be contained in the data word bitstream. These series of ON-OFF pulses are detected by a label-reading device (query device), and the amplitude changes of its CW-HF signal are ascertained. These amplitude changes are caused by the electromagnetically coupled or HF-antenna-coupled RFID tag, which charges and discharges the resonance circuit or antenna of the label-reading device or query device.

In an exemplary embodiment of the invention, an RFID tag has a digital input for detecting a change in the voltage, in the current or in the resistance of a sensor connected to the digital input. The sensor state of the digital input can ascertain whether the bit values of the data word bitstream can be inverted. The difference between the two data word bitstreams yields the change in the sensor (open or closed), as a result of which whatever the sensor shows is displayed, i.e. an open or a closed valve, a circuit breaker that is switched on or triggered, or the like. The sensor can be supplied with voltage or current by an external source or by the RFID tag itself, which then feeds part of the current of the electromagnetically coupled or HF-antenna-coupled continuous wave of the query device or label-reading device.

The sensor can be, for example, an electromechanical switch, a transistor, a Hall-effect element, or a phototransistor.

Another exemplary embodiment of the RFID tag has an analog input for detecting an analog sensor signal that is represented by a variable voltage, current or resistance value.

The analog input can be converted by a voltage comparator into an ON-OFF high-low representation.

The voltage or current for supplying one or more analog sensors can be drawn from an external source or from the RFID tag, which uses part of the energy from the electromagnetically coupled or HF-antenna-coupled continuous wave from the query device or label-reading device. The analog sensor or sensors can be an RTD (resistance temperature detector), a thermoelement, a piezoelectric pressure measured-value transducer or the like.

The detected value can be, for example, the following: pressure, temperature, acceleration, vibration, moisture content, gas fraction, density, flow rate, sound intensity, radiation, magnetic flux, pH value, etc.

The voltage or current for supplying one or more sensors can be drawn from an external source or from the RFID tag, which then feeds part of the energy from the electromagnetically coupled or HF-antenna-coupled continuous wave from the query device or label-reading device.

The RFID tag can be made of a single semiconductor IC chip, or it can consist of several semiconductor single chips in an individual IC housing. It is likewise taken into account and falls within the scope of an exemplary embodiment of the invention that multiple module RFID tags with several discrete electronic modules are integrated into the above-mentioned embodiments, including, for example, microcontrollers, memories, digital logic circuits, analog circuits and discrete and/or monolithic measured-value transducers or sensors.

A refinement of an exemplary embodiment of the invention comprises an RFID tag with a sensor input that causes logic circuits in the RFID tag to modify data contents.

If the RFID tag is passive, it has no internal current storage capability, and the current for its circuits comes from a near-field or far-field continuous wave high frequency (CW-HF) source. This is installed, for example, in a transportation system (for instance, a ground vehicle or aircraft) or in a warehouse.

When the RFID tag comes close to the CW-HF field, the RFID tag draws energy from the field via electromagnetic or HF-coupling.

The RFID tag located nearby influences the amplitude of the CW-HF carrier. The CW-HF generator has a query device that recognizes changes in the amplitude of the CW-HF carrier, and it has an evaluation circuit that, over a period of time, searches for one or more patterns in these amplitude changes. If a recognizable pattern is ascertained, then this means that an RFID tag was discovered, and the information in this recognizable pattern can be used.

The RFID tag can also supply the sensor with electric current.

The RFID tag generates a data word bitstream that is read by a query device or by a label-reading device. The data word bitstream contains information that is influenced by a signal value of the sensor. If the signal value of the sensor changes, then the information of the data word bitstream also changes.

An exemplary embodiment of the present invention comprises numerous connections between sensors and transponders by connection structures V. The connection structures V can be configured in multifaceted ways. For example, these are elements to relay signals. Preferably, the connection structures are configured in such a way that they also allow mechanical contact between transponders and sensors.

For this purpose, it is advantageous for the connection means to be flexible.

In order to allow an adaptation of the connection means to geometric requirements, it is especially advantageous to configure said connection means as strips.

Thanks to the strip-like configuration, the connection structures can be more conveniently incorporated into containers for the shipment of objects.

The connection structures V are preferably between 5 cm and 1 meter in length, preferably between 10 cm and 80 cm.

The connection structures V bring about a thermal insulation between the sensor S and the transponder T. In order to further improve the insulation, it is advantageous for the connection element to consist at least partially of a thermally insulating material.

In an exemplary embodiment of the invention, it is provided that at least individual sensor-transponder units are already integrated into the containers during the production process of said containers. This is done, for example, in that blanks made of a folding material and provided for the production of a box are connected to the sensor-transponder units. Here, it is especially advantageous to first make the connection with the sensor-transponder units and then to fold the blanks into the desired shape to form the container.

However, it is likewise possible to first make or provide the containers and to subsequently equip them with the sensor-transponder units according to an exemplary embodiment of the present invention.

Of course, before the final production of the container, a first sensor-transponder unit can be incorporated into the areas intended for the production of the container and, after the production of the container—if desired at a much later point in time—it can be provided with a second sensor-transponder unit.

In particular, it is advantageous to incorporate at least one sensor of a sensor-transponder unit into the container while said container is being filled. This has the advantage that the sensor can be brought into contact with at least some of the objects.

When a temperature sensor is used, it is especially advantageous for it to be in contact with at least one object, at least in some places. This ensures that the sensor has the same temperature as the objects that are to be monitored.

The number of sensors and transponders is adapted to the requirements of the monitoring that is to be carried out.

For example, a first embodiment of the sensor-transponder unit comprises one transponder T and one sensor S.

By the same token, it is possible to connect one sensor to several transponders.

By the same token, it is possible to connect one transponder to several sensors.

The monitoring capability is improved by using several sensors.

By using several transponders, it is possible to carry out reading procedures for status information more quickly and/or reliably.

In each case, the sensors and transponders are advantageously arranged as a function of the requirements (close to the objects to be monitored or to the outside contact sites that are likewise to be monitored).

The sensor or sensors can be digital or analog, as described above.

The reading unit (query device or label-reading device) detects the amplitude changes or frequency changes of an electromagnetic signal brought about by the transponder or transponders and converts them into the serial data word bitstream.

Thus, an exemplary embodiment of the present invention provides for a system in which RFID tags are used in an especially advantageous manner such that they reliably give information about a status and/or a current location of at least one object.

RFID systems according to an exemplary embodiment of the present invention preferably do not transmit only identification and position data, but also temperature, moisture, shock-absorption, biometric and other data. This data can be recorded and evaluated.

Refinements of an exemplary embodiment of the present invention provide for transforming data into information and linking it with additional information from application systems.

Contact-free reading of many objects simultaneously and depicting logistics sequences in the software architecture helps to use acquired real-time information to improve the logistics processes (processing, handling and/or transportation processes in the logistics system).

The tracking capability employing RFID technology helps to improve the security thanks to optimized transportation processes.

The RFID technology according to an exemplary embodiment of the present invention makes it possible to depict a worldwide logistics chain in real-time and to provide information about the current location, status, origination and destination location as well as, if applicable, also sensor data.

The handling of sensitive objects can be detected by sensor systems in a timely fashion and can be tracked precisely with respect to the position and the point in time.

The logistical sequences are configured so as to be automated and secure, making use of RFID identification, temperature and humidity measurement as well as the integration of incoming inspections. For this purpose, it is advantageous for all of the relevant information to be processed by means of real-time processes. Among other things, the following partial processes are involved:
arrival of the object,
transportation to/from interim storage facilities,
placement into and removal from interim storage facilities,
real-time monitoring of the movements (combination of identification and reading zones).

Monitored information comprises, among other things:
container identification (unambiguously encoded serial numbers) per passive RFID tag (linking with the content data only after authorization and decoding).
ambient factors such as temperature and humidity. If the values exceed or fall below certain ranges over periods of time, for example, the classification of individual substances changes and so does the capability for further processing.
inventory monitoring in the interim storage facility:
all tags are read within predefinable time intervals and/or upon request.

In individual exemplary embodiments of the invention, it is provided that only changes are detected. As an alternative, it is possible to store a data history.

An exemplary embodiment of the present invention makes it possible to use warning messages. The warning messages can be used to change logistical processes—especially the sorting, storage and/or transportation of the objects—or to initiate a new logistical process—for example, a new transportation process.

It is advantageous to use a server in order to control the system. A program serves to operate the server, and this program is preferably stored on a computer program product—for example, on a suitable storage medium.

In this manner, it is possible to link sensors and, if applicable, also actuators. Advantageously, filtering and, if applicable, correlating the measured data is carried out in real time so that the logistical processes can be directly influenced.

Data can be made available via various communication channels, for example, the data channels of the transponders, mobile communication systems (PLUTUS, GSM, GPRS, UMTS). This makes it possible to:
link the sensors and the actuators;
filter and correlate the sensor data in real time in the process context;
integrate the existing HMMS application;
provide the data and messages via different channels (hand-held device, telephone, portal, etc.).

The possibility of achieving real-time information using RFID tags and of integrating this information into the information architecture is the concept of the sensor-based services.

It is especially advantageous to store status information received by the reading devices and/or to transmit it to the data processing unit (server).

Advantageously, the ascertained status information is compared to specified data. In this manner, it is possible to ascertain deviations and to quickly determine the extent to which there is a need to change the logistical processes.

Consequently, this especially makes it possible to promptly inform an intended recipient or the sender of the object about the transportation status.

In this manner, handling systems and/or transportation systems are capable of achieving an improved cooperation that, with the same information level, is location-independent and also capable of generating a suitable response on the basis of the sensor information obtained.

As a result, the logistical processes can be carried out more quickly and reliably.

### LIST OF REFERENCE NUMERALS

10 container
11 lid surface
12 capacitive element
20 object
21 RFID tag, identification device
30 sensor, electrically conductive layer/strip
40 data processing unit
50 position-finding device
60 monitoring center
61 message-receiving means, message-receiving device
70 atmosphere measuring device
80 communication module, interface
90 object detection device, edge antenna
100 protective covering
110 pallet bottom
401 sending location
409 receiving location
600 transponder
601 container
602 reading device
701 sensor
702 to 705 objects
706 container
801 sensor strips
802 to 807 objects
808 container

1-27. (canceled)

28. A method for monitoring a container for holding at least one object, the method comprising:
acquiring measured data about an object with a sensor;
transmitting the measured data to a transponder, the transponder being separated from the sensor by an interlayer that absorbs or reflects electromagnetic radiation;
transmitting status information from the transponder to a reading unit as a function of the measured data;
supplying energy to the transponder from the reading unit; and
relaying the energy from the transponder to the sensor.

29. The method recited in claim 28, comprising evaluating the status information using the reading unit.

30. The method recited in claim 28, comprising storing the status information.

31. The method recited in claim 28, comprising storing the status information in a storage medium installed in the container.

32. The method recited in claim 28, comprising storing the status information in the reading unit and/or in a data processing unit that is in communication with the reading unit.

33. The method recited in claim 28, comprising evaluating the status information in a data processing unit that is in connection with the reading unit.

34. The method recited in claim 28, comprising performing a handling procedure of the container as a function of an evaluation of the status information.

35. The method recited in claim 28, comprising performing a logistical process in a logistics system as a function of an evaluation of the status information.

36. The method recited in claim 35, wherein the logistical process comprises diverting the container out of a given transportation process.

37. The method recited in claim 35, wherein the logistical process comprises a selection of another mode of transportation.

38. The method recited in claim 28, comprising determining a position of the transponder.

39. The method recited in claim 38, comprising storing the position of the transponder.

40. The method recited in claim 38, comprising storing the position of the transponder in a data processing unit in communication with the reading unit.

41. The method recited in claim 38, comprising associating the position of the transponder with the status information.

42. The method recited in claim 28, comprising establishing a signal line between the sensor and the transponder via a connection element.

43. The method recited in claim 42, wherein the connection element comprises at least one wire.

44. The method recited in claim 42, wherein the connection element comprises at least one optical waveguide.

45. The method recited in claim 28, wherein the sensor is closer to the object than the transponder is.

46. The method recited in claim 28, wherein the interlayer has a thermally insulating effect.

47. The method recited in claim 28, wherein the interlayer has a shock-absorbing effect.

48. A logistics system for transporting a container holding at least one object from a sending location to a receiving location, the logistics system comprising:
a sensor associated with the container;
a transponder associated with the sensor, the transponder being separated from the sensor by an interlayer that absorbs or reflects electromagnetic radiation; and
a reader that interacts with the transponder, the reader being arranged in the container in such a way that measured data about an object acquired by the sensor is transmitted to a reading unit, the reader being adapted to supply energy to the sensor via the transponder.

49. A system for monitoring a container for holding at least one object, the system comprising:
means for acquiring measured data about an object with a sensor;
means for transmitting the measured data to a transponder, the transponder being separated from the sensor by an interlayer that absorbs or reflects electromagnetic radiation;
means for transmitting status information from the transponder to a reading unit as a function of the measured data;
means for supplying energy to the transponder from the reading unit; and
means for relaying the energy from the transponder to the sensor.
